(19) United States
(12) Patent Application Publication
(10) Pub. No.: US 2014/0138104 A1
(43) Pub. Date: May 22, 2014

(54) Fire Fighting Foam Composition

(71) Applicants: Nicolas Robinet, Reims (FR); Chantal Smett, Reims (FR)

(72) Inventors: Nicolas Robinet, Reims (FR); Chantal Smett, Reims (FR)

(73) Assignee: EUROSTAR BIDCO LTD., Lancashire (GB)

(21) Appl. No.: 14/003,643

(22) PCT Filed: Mar. 11, 2011
(86) PCT No.: PCT/IB2011/001065

§ 371 Date: Nov. 14, 2013

(51) Int. Cl. A62D 1/02

(52) U.S. Cl. CPC A62D 1/0071
USPC 169/46; 252/3

(57) ABSTRACT

A fire fighting foam composition is disclosed comprising water; diutan gum; one or more surfactants; and one or more water-miscible organic solvents. In some exemplary aspects, the foam may be a fluorine-free foam composition or a reduced fluorine content foam composition.

### BACKGROUND OF THE INVENTION

Fire fighting foams such as aqueous film-forming foams (AFFF) and alcohol-resistant aqueous film-forming foams (AR-AFFF) have been widely used against fires fueled by flammable liquids (i.e., class B fires). These foams generally include water along with a film-forming agent such as a water-soluble polymer and one or more surfactants, optionally with one or more additives. Among the more effective surfactants have been a variety of fluorinated surfactant compounds. These compounds, however, can have long residual presence in the environment and have come under increasing scrutiny with respect to environmental regulations. Regulations restricting the use of these compounds have been promulgated or are being considered in a number of jurisdictions. The prospect of such environmental regulations may also have a negative impact on the commercial availability and/or drive up the cost of fluorinated surfactant compounds. This has in turn prompted a need for effective fire fighting foam compositions such as AFFF and AR-AFFF compositions that have limited amounts of or are free from fluorinated surfactant compounds. Additionally, there continues to be a need for new fluorinated surfactant-containing fire fighting foam compositions that may offer improved effectiveness, cost, or both.

### BRIEF DESCRIPTION OF THE INVENTION

According to an exemplary embodiment, a fire fighting foam composition is provided comprising
water;
diutan gum;
one or more surfactants; and
one or more water-miscible organic solvents.

In another exemplary embodiment, the fire fighting foam composition has a reduced fluorine content and/or fluorinated surfactant content, as described herein, or is substantially free of fluorine and/or fluorinated surfactant.

In another exemplary embodiment, a fire fighting foam composition is provided comprising
water;
diutan gum;
an alkyl polyglycoside;
one or more anionic surfactants; and
one or more glycol solvents;
the fire fighting foam composition being substantially free of fluorinated surfactants.

### DETAILED DESCRIPTION OF THE INVENTION

Diutan gum may be used in the compositions described herein in various amounts. In one exemplary embodiment, diutan gum may be present in a minimum amount of at least 1.6% by weight and in another exemplary embodiment at least 1.1% by weight. In another exemplary embodiment, diutan gum may be present in a maximum amount of less than or equal to 0.8% by weight and in another exemplary embodiment less than or equal to 0.6% by weight.

Diutan gum is a polysaccharide polymer having repeating units of D-glucose, D-gluconaric acid, and 6-deoxy L-mannose. One type of diutan gum useful in the compositions described herein may be characterized by the formula

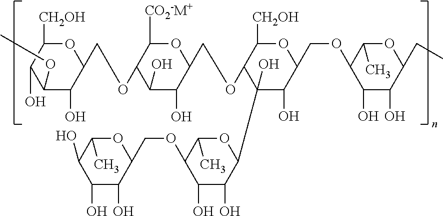

where and M is a cation that may be Na, K, or ½Ca and ½Mg and n is a number that is produced according to the techniques disclosed in U.S. Pat. No. 7,868,167, the disclosure of which is incorporated herein by reference in its entirety.

Diutan gum may be produced by biopolymer fermentation techniques as described, for example, in the above-referenced U.S. Pat. No. 7,868,167. The specific characteristics and properties of diutan gum may vary depending on the techniques by which it is manufactured. In an exemplary embodiment, the diutan gum used in the compositions described herein is a diutan gum as described in the above referenced U.S. Pat. No. 7,868,167. In another exemplary embodiment, the diutan gum used in the compositions described herein is KELCO-CRETE® DG-F biopolymer manufactured by CPKelco.

In some exemplary embodiments, the compositions described herein are free from, or contain only limited amounts of, fluorine including fluorine content derived from fluoro-substituted surfactants. Although not being bound by any particular theory or mechanism, it is believed that diutan gum provides water retention properties that are surprisingly able to provide useful foams without the use of or with only limited amounts of fluorinated surfactants. In some exemplary embodiments, the compositions described herein have less than 1% by weight of fluorine. In other exemplary embodiments, the compositions described herein have less than 0.5% by weight of fluorine. In still other exemplary embodiments, the compositions described are free of fluorine. In further exemplary embodiments, the compositions described herein have less than 2% by weight of fluorinated surfactants. In still further exemplary embodiments, the compositions described herein have less than 1% by weight of fluorinated surfactants. In still further exemplary embodiments, the compositions described are free of fluorinated surfactants.

The compositions described herein also include one or more surfactants. The amount of surfactant can vary widely depending on the particular surfactant or combination of surfactants, but can generally range between 5 and 12 weight percent of the fire fighting foam composition. Surfactants for fire fighting foam applications are well-known in the art, and include anionic surfactants, nonionic surfactants, amphoteric surfactants, and cationic surfactants. Anionic surfactants may include, for example, alkyl, alkyl ether, or alkylaryl sulfates (e.g., sodium lauryl sulfate, sodium lauryl ether sulfate), sulfonates (e.g., dioctyl sodium sulfosuccinate), or carboxylates. In some exemplary embodiments, the alkyl or alkyl ether groups on the anionic surfactants may be substituted with substituents such as fluoro (except in cases where the fire fighting composition is fluorine-free, and may have from 8 to 16 carbon atoms, and from 8 to 10 carbon atoms in a more specific embodiment. In an exemplary embodiment, the one or more surfactants are selected from the group consisting of a C8-C10 alkyl sulfate, a C10-C14 alkyl ether sulfate, a succinate salt, and combinations including one or more of the foregoing. The amount of surfactant in the composition can vary widely depending on the type of surfactant(s) used

Nonionic surfactants may include, for example, fatty alcohols (which in some embodiments have linear or branched C12 to C14 alkyl groups, e.g., cetyl alcohol, stearyl alcohol, oleyl alcohol), polyoxethylene or polyoxypropylene glycol alkyl or alkylphenol ethers (e.g., CH₃—(CH₂)₁₀₋₁₆—(O—C₂H₄)₁₋₂₅—OH, CH₃—(CH₂)₁₀₋₁₆—(O—C₃H₆)₁₋₂₅—OH, CH₃—(CH₂)₇₋₈—C₆H₄—(O—C₃H₆)₁₋₂₅—OH), block copolymers of polyoxyethylene and polyoxypropylene, and others as known in the art. A particularly useful class of nonionic surfactants for fire fighting foam are alkyl glycosides and polyglycosides as described, for example, in U.S. Pat. No. 5,207,932, the disclosure of which is incorporated herein by reference in its entirety.

Amphoteric surfactants may include, for example, a variety of compounds having an aliphatic portion having anionic moieties attached thereto along with amino or ammonium moieties. Examples include higher alkyl (C6-C14) betaines and sulfobetaines, CHAPS (3-[(3-cholamidopropyl)dimethylammonio]-1-propanesulfonate), cocamidopropyl hydroxysultaine,

Solvents may include glycol ethers such as diethylene glycol monoalkyl ethers, ethylene glycol monoalkyl ether, propylene glycol monoalkyl ethers, dipropylene glycol monoalkyl ethers, as well as other hydroxyl-substituted ethers such as 1-butoxyethoxy-2-propanol. Other useful solvents may include various polyols such as higher alkyl glycols such as hexylene glycol, glycerine, and the like as described in various US patents, including U.S. Pat. Nos. 3,579,446, 3,422,011, 3,457,172, and 5,616,273, the disclosures of which are incorporated herein by reference in their entirety. The solvents used for their foam aid properties may also provide freeze protection for the foam or foam concentrate composition, but additional solvents may be included as part of an antifreeze package. Such antifreeze compounds may include lower alkyl glycols such as ethylene glycol, propylene glycol, propylene glycol, as well as salts and other solids that can reduce the freezing point, such as sodium, potassium, and urea.

The compositions described herein may also include various other additives such as sequestration agents, pH buffers, anticorrosion additives, antimicrobial additives, and the like as are well-known in the art as described, for example, in “A Firefighter's Guide to Foam”, published by National Foam, Inc. or in BS EN 13565-1 and BS EN 13565-2, or in NFPA Standards, the disclosure of each of which is incorporated herein by reference in its entirety.

The fire fighting foam composition may also include, in addition to diutan gum, one or more other film formers or thickeners, including but not limited to water-soluble polymers such as described in US published patent application 2010/0276625A1, polysaccharide gums (e.g., xanthan gum, pectic acid, alginic acid, agar, rhamsam gum, welan gum, galactomannan gum, mannan gum), cellulose, dextran, hydroxyethyl cellulose, and starch.

The compositions described herein may be used as a concentrate in foam generating equipment using aspirated foam generating devices, non-aspirated foam generating devices, foam chambers, or sprinkler systems, as described in the above-referenced “Firefighters Guide to Foam”, BS EN 13565 standards, or NFPA Standards. Foams may be applied directly to the flame or indirectly (i.e., applied to an adjacent surface and allowed to flow onto the flame). In one exemplary embodiment, dilution rates for generating a foam can range from 1% to 6%. The water used for dilution may be fresh, brackish, or sea water, or virtually any water-containing solution.

The compositions and their use are further described below in the following non-limiting examples.

### EXAMPLES

Film-forming foam compositions (FFF) were prepared having the compositions (wt. %) as set forth in Table 1.

TABLE 1

| Ingredient | C. Ex. 1 | Ex. 1 | C. Ex. 2 | Ex. 2 |
|---|---|---|---|---|
| Water | 70.48% | 70.48% | 68.5% | 68.5% |
| Urea | 5% | 5% | 5% | 5% |
| Sodium alkyl | 1.76% | 1.76% | 3.08% | 3.08% |
| sulfate | | | | |
| surfactant | | | | |
| Sodium alkyl | 1.1% | 1.1% | 0% | 0% |
| ether sulfate | | | | |
| surfactant | | | | |
| Alkyl | 0.45% | 0.45% | 0% | 0% |
| sulfosuccinate | | | | |
| surfactant | | | | |
| Amphoteric | 0% | 0% | 0.349% | 0.349% |
| perfluorinated | | | | |
| surfactants | | | | |
| Alkyl glycoside | 0.48% | 0.48% | 0.3% | 0.3% |
| Fatty alcohol | 0.5% | 0.5% | 0% | 0% |
| Biocide | 0.00135% | 0.00135% | 0.00135% | 0.00135% |
| Preservative | | | | |
| Diutan gum | 0% | 1.1% | 0% | 0.5% |
| Xanthan gum | 1.1% | 0% | 0.5% | 0% |
| Propylene | 6.16% | 6.16% | 0% | 0% |
| glycol butyl | | | | |
| ether | | | | |
| Propylene | 9.36% | 9.36% | 0% | 0% |
| glycol | | | | |
| Butyl di-glycol | 0% | 0% | 9% | 9% |
| Ethylene glycol | 0% | 0% | 11.15% | 11.15% |

Materials were added stepwise, with the mixture maintained at 45° C. The diutan gum was added dissolved in the propylene glycol butyl ether, and the xanthan gum was added dissolved in the butyl di-glycol.

Each of the foam compositions was used at a 6% dilution to control a polar organic (acetone)-fueled fire and a non-polar organic (heptane)-fueled fire according to the Small Scale Fire Test as set forth in BS EN 1568:3 (2008) Annex I for the acetone-fueled fire and BS EN 1568:4 (2008) Annex I for the heptane-fueled fire. The results are set forth in Table 2 for the acetone-fueled fire and Table 3 for the heptane-fueled fire.

TABLE 2
Acetone Fueled Small Scale Fire Test

| | C. Ex. 1 | Ex. 1 | C. Ex. 2 | Ex. 2 |
|---|---|---|---|---|
| Concentration | 6% | 6% | 6% | 6% |
| (%) | | | | |
| Temperatures: | | | | |
| (° C.) | | | | |
| Water | 13 | 15 | 13 | 13 |
| Acetone | 15 | 15 | 15 | 15 |
| Ambient | 15 | 15 | 15 | 15 |
| x Application | 6.5 | 6.5 | 6.5 | 6.5 |
| rate (l/m²/ | | | | |
| min) | | | | |
| Time to percent | | | | |
| of fire | | | | |
| controlled | | | | |
| (sec): | | | | |
| 50% | 13 | 14 | 21 | 21 |
| 80% | 20 | 23 | 33 | 33 |
| 90% | 29 | 30 | 45 | 40 |
| 99% | 36 | 36 | 55 | 45 |
| Extinction | 43 s | 42 s | 62 s | 50 s |
| Time of | 2 mn 00 s | 2 mn 00 s | 2 mn 00 s | 2 mn 00 s |
| termination of | | | | |
| foam | | | | |
| application | | | | |
| Time of | 8 mn 00 s | 8 mn 38 s | 8 mn 30 s | 8 mn 30 s |
| reignition | | | | |
| commencement | | | | |
| Time of | 12 mn 15 s | 13 mn 55 s | 12 mn 30 s | 12 mn 30 s |
| complete | | | | |
| reignition | | | | |

TABLE 3
Heptane Fueled Small Scale Fire Test

| | C. Ex. 1 | Ex. 1 | C. Ex. 2 | Ex. 2 |
|---|---|---|---|---|
| Concentration | 6% | 6% | 6% | 6% |
| (%) | | | | |
| Temperatures: | | | | |
| (° C.) | | | | |
| Water | 15 | 14 | 13 | 15 |
| Heptane | 15.5 | 15 | 15 | 15.5 |
| Ambient | 17 | 18 | 15 | 17 |
| x Application rate | 3 | 3 | 3 | 3 |
| (l/m²/min) | | | | |
| Time to percent | | | | |
| of fire controlled | | | | |
| (sec): | | | | |
| 50% | 24 | 24 | 30 | 40 |
| 80% | 32 | 32 | 48 | 50 |
| 90% | 39 | 38 | 62 | 52 |
| 99% | 36 | 36 | 55 | 45 |
| Extinction | 45 | 44 | 70 | 57 |
| Time of | 2 mn 00 s | 2 mn 00 s | 2 mn 00 s | 2 mn 00 s |
| termination of | | | | |
| foam application | | | | |
| Time of reignition | 11 mn 15 s | 11 mn 33 s | 8 mn 40 s | 10 mn 00 s |
| commencement | | | | |
| Time of complete | 12 mn 50 | 13 mn 15 | 9 mn 30 s | 12 mn 30 s |
| reignition | | | | |

The results in Tables 2 and 3 illustrate that the diutan gum-containing foam compositions offer excellent fire suppression performance. In the fluorine-free compositions of Comparison Example 2 and Example 2, the diutan gum-containing foam composition of Example 2 provides significantly faster fire extinction with significantly longer (better) time for reignition to occur.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fire fighting foam composition, comprising:
water;
diutan gum;
one or more surfactants; and
one or more water-miscible organic solvents.

2. The composition of claim 1, wherein the composition comprises less than 1% fluorine by weight.

3. The composition of claim 1, wherein the composition comprises less than 0.5% fluorine by weight.

4. The composition of claim 1, wherein the composition is substantially fluorine free.

5. The composition of claim 1, wherein the composition comprises less than 2% by weight of fluorinated surfactants.

6. The composition of claim 1, wherein the composition comprises less than 1% by weight of fluorinated surfactants as a fire fighting foam composition.

7. The composition of claim 1, wherein the composition is free of any fluorinated surfactant.

8. The composition of claim 7, comprising from 0.1 to 1.5 percent by weight of diutan gum.

9. The composition of claims 1, wherein the one or more surfactants includes an alkyl polyglycoside.

10. The composition of claim 9, wherein the one or more surfactants further includes one or more anionic surfactants.

11-13. (canceled)

14. The composition of claim 1, wherein the one or more surfactants includes a fatty alcohol.

15. The composition of claim 1, wherein the one or more surfactants are selected from the group consisting of a C8-C10 alkyl sulfate, a C10-C14 alkyl ether sulfate, a succinate salt, and combinations including one or more of the foregoing.

16. A fire fighting foam composition, comprising:
water;
diutan gum;
an alkyl polyglycoside;
one or more anionic surfactants; and
one or more glycol solvents;
said fire fighting foam composition being substantially free of fluorinated surfactants.

17. The composition of claim 1, comprising from 0.1 to 1.5 percent by weight of diutan gum.

18. The composition of claim 16, wherein the one or more surfactants are selected from the group consisting of a C8-C10 alkyl sulfate, a C10-C14 alkyl ether sulfate, a succinate salt, and combinations including one or more of the foregoing.

19. The composition of claim 16, wherein the one or more glycol solvents include an alkylene glycol, an alkylene glycol alkyl ether, or both an alkylene glycol and an alkylene glycol alkyl ether.

20. The composition of claim 16, further comprising urea.

21. A method of fighting a fire, comprising forming a foam comprising the composition of claim 1, and applying the foam directly or indirectly onto the fire.

22. The method of fighting a fire, according to claim 21, wherein in the step of forming a foam the composition of the foam is free of any fluorinated surfactant.

23. The method of fighting a fire, according to claim 21, wherein in the step of forming a foam the composition of the foam comprises:
water;
diutan gum;
an alkyl polyglycoside;
one or more anionic surfactants; and
one or more glycol solvents
and the composition of the foam is substantially free of fluorinated surfactants.
